(19) United States
(12) Patent Application Publication
(10) Pub. No.: US 2023/0144288 A1
(43) Pub. Date: May 11, 2023

(54) METHOD FOR DETERMINING INTERSECTION MISSING TRAFFIC RESTRICTION INFORMATION, AND ELECTRONIC DEVICE

(71) Applicant: BEIJING BAIDU NETCOM SCIENCE TECHNOLOGY CO., LTD., Beijing (CN)

(72) Inventors: Yongkang Liu, Beijing (CN); Xipeng Zong, Beijing (CN); Jianzhong Yang, Beijing (CN); Zhen Lu, Beijing (CN); Deguo Xia, Beijing (CN); Tingting Cao, Beijing (CN)

(21) Appl. No.: 18/090,651

(22) Filed: Dec. 29, 2022

(30) Foreign Application Priority Data
Jan. 7, 2022 (CN) 202210024682.4

(51) Int. Cl. G08G 1/097; G01C 21/00; G08G 1/01

(52) U.S. Cl. CPC G08G 1/097; G01C 21/3815; G08G 1/0125

(57) ABSTRACT

The disclosure provides a method for determining an intersection missing traffic restriction information and an electronic device. The method includes: obtaining trajectory information corresponding to the intersection; determining a traffic anomaly occurring at the intersection based on the trajectory information; obtaining lane line information of a road section connected by the intersection; and determining the intersection missing traffic restriction information based on the lane line information.

### CROSS-REFERENCE TO RELATED APPLICATIONS

This application is based on and claims priority to Chinese Patent Application No. 202210024682.4, filed on Jan. 7, 2022, the entire content of which is incorporated herein by reference.

### TECHNICAL FIELD

The disclosure relates to the field of computer technology, and provides a method for determining an intersection missing traffic restriction information, and an electronic device and a storage medium thereof.

### BACKGROUND

Traffic restriction information refers to regulations of a dispersion, ban, restriction or direction set for a movement of vehicles and pedestrians on the road and other traffic-related activities by relevant agencies, which are vital for people's daily travel. However, the related art mainly relies on human labor to detect the traffic restriction information, which presents low efficiency, low accuracy and high labor cost.

### SUMMARY

The embodiments of the disclosure provide a method for determining an intersection missing traffic restriction information, and an electronic device and a storage medium thereof.

According to a first aspect of the disclosure, there is provided a method for determining an intersection missing traffic restriction information, including: obtaining trajectory information corresponding to the intersection; determining a traffic anomaly occurring at the intersection based on the trajectory information; obtaining lane line information of a road section connected by the intersection; and determining the intersection missing traffic restriction information based on the lane line information.

According to a second aspect of the disclosure, there is provided an electronic device. The electronic device includes: at least one processor and a memory, connected in communication with said at least one processor, wherein the memory stores therein instructions executable by said at least one processor, the instructions, that are executed by said at least one processor, implements a method for determining an intersection missing traffic restriction information including: obtaining trajectory information corresponding to the intersection; determining a traffic anomaly occurring at the intersection based on the trajectory information; obtaining lane line information of a road section connected by the intersection; and determining the intersection missing traffic restriction information based on the lane line information.

According to a third aspect of the disclosure, there is provided a non-transitory computer-readable storage medium having computer instructions stored thereon. The computer instructions are configured to cause a computer to implement a method for determining an intersection missing traffic restriction information including: obtaining trajectory information corresponding to the intersection; determining a traffic anomaly occurring at the intersection based on the trajectory information; obtaining lane line information of a road section connected by the intersection; and determining the intersection missing traffic restriction information based on the lane line information.

It should be understood that the content described in this section is not intended to identify key or important features of the embodiments of the disclosure, nor is it intended to limit the scope of the disclosure. Additional features of the disclosure will become readily appreciated from the following descriptions.

### BRIEF DESCRIPTION OF THE DRAWINGS

Drawings are explanatory, serve to explain the disclosure, and are not construed to limit embodiments of the disclosure, in which:

FIG. 1 is a flowchart of a method for determining an intersection missing traffic restriction information according to a first embodiment of the disclosure.

FIG. 2 is a schematic diagram showing a scenario of cross-intersection traffic restriction information in a method for determining an intersection missing traffic restriction information according to a second embodiment of the disclosure.

FIG. 3 is a flowchart of a method for determining an intersection missing traffic restriction information according to a third embodiment of the disclosure.

FIG. 4 is a flowchart of a method for determining an intersection missing traffic restriction information according to a fourth embodiment of the disclosure.

FIG. 5 is a flowchart of a method for determining an intersection missing traffic restriction information according to a fifth embodiment of the disclosure.

FIG. 6 is a schematic diagram of a scenario of a problematic path in a method for determining an intersection missing traffic restriction information according to a sixth embodiment of the disclosure.

FIG. 7 is a block diagram of an apparatus for determining an intersection missing traffic restriction information according to the first embodiment of the disclosure.

FIG. 8 is a block diagram of an electronic device implementing a method for determining an intersection missing traffic restriction information according to the embodiments of the disclosure.

### DETAILED DESCRIPTION

The following describes the exemplary embodiments of the disclosure with reference to the accompanying drawings, which includes various details of the embodiments of the disclosure to facilitate understanding, which shall be considered merely exemplary. Therefore, those of ordinary skill in the art should recognize that various changes and modifications can be made to the embodiments described herein without departing from the scope and spirit of the disclosure. For clarity and conciseness, descriptions of well-known functions and structures are omitted in the following description.

Artificial Intelligence (AI) is a technical science that studies and develops theories, methods, technologies and application systems for simulating, extending and expanding human intelligence. Currently, AI technology has been widely used for its advantages of high degree of automation, high accuracy and low cost.

Intelligent traffic is a comprehensive transport system that effectively integrates advanced science and technology, such as information technology, computer technology, data communication technology, sensor technology, electronic control technology, automatic control theory, operations research and AI, to traffic transport, service control and vehicle manufacturing to strengthen a connection among vehicles, roads and users, so as to ensure safety, improve efficiency, improve the environment and save energy.

Deep Learning (DL) is a new research direction in the field of Machine Learning (ML). The DL is a technology to learn internal laws and representation levels of sample data to enable a machine to have the analyzing and learning abilities as humans and to recognize data of a text, image, sound and the like. The DL is widely used in speech and image recognitions.

FIG. 1 is a flowchart of a method for determining an intersection missing traffic restriction information according to a first embodiment of the disclosure.

As shown in FIG. 1, the method for determining an intersection missing traffic restriction information according to the first embodiment of the disclosure includes S101-S104.

At S101, trajectory information corresponding to an intersection is obtained.

It is to be noted that the execution subject of the method for determining an intersection missing traffic restriction information of the embodiments of the disclosure may be a hardware device having data and information processing capabilities and/or a software necessary to drive the hardware device to work. In some examples, the execution subject may include a workstation, a server, a computer, a user terminal and other intelligent devices. The user terminal includes, but is not limited to, a mobile phone, a computer, an intelligent voice interaction device, a smart home appliance and a vehicle terminal.

In the embodiments of the disclosure, the trajectory information corresponding to the intersection may be obtained. It should be noted that types of the intersection and the trajectory information are not further limited here. The trajectory information may include a plurality of trajectory points.

In an embodiment, the intersection may be a complex intersection or a crossroad. It should be noted that the complex intersection refers to an intersection composed of at least two junctions and/or at least two road sections, which includes but not limited to a crossing and a T-shaped intersection.

In an embodiment, the trajectory information corresponding to the intersection may include the trajectory information within a set area of the intersection, and a shape and a size of the set area are not further limited. For example, the set area may be an area formed by extending outward according to a set value from the position of the intersection as the center. For example, the set area may be a rectangular area centered on the position of the intersection.

In an embodiment, the trajectory information corresponding to the intersection may include the trajectory information of the road section connected by the intersection. The road section may include an entry road section and an exit road section.

At S102, it is determined that a traffic anomaly occurs at the intersection based on the trajectory information.

In an embodiment, determining a traffic anomaly occurring at the intersection based on the trajectory information may include determining the intersection meeting a set condition of an occurrence of the traffic anomaly based on the trajectory information, thereby determining that a traffic anomaly occurs at the intersection. It should be noted that the set condition of an occurrence of a traffic anomaly may be set as desired, which is not limited here. For example, there may be one or more set condition of the traffic anomaly.

In an embodiment, determining a traffic anomaly occurring at the intersection based on the trajectory information may include inputting the trajectory information into a set model, which is used to recognize a traffic status of the intersection based on the trajectory information and output the traffic status of the intersection. The traffic status includes normal traffic status and abnormal traffic status. It should be noted that the set model may be set as desired, which is not limited here. For example, there may be one or more set model.

At S103, lane line information of a road section connected by the intersection is obtained.

It should be noted that a type of the road section connected by the intersection and a category of the lane line information are not further limited herein. For example, the road section connected by the intersection may include an entry road section and an exit road section of the intersection. For example, the lane line information may include color, number, shape and dotted or solid line of the lane line.

In an embodiment, obtaining the lane line information of the road section connected by the intersection may include collecting a picture of the intersection and extracting the lane line information of the road section connected by the intersection from the picture of the intersection. For example, the picture of the intersection may be collected periodically at a set interval, which is not further limited here. For example, the set interval may be one day. It should be noted that the picture of the intersection may be updated periodically along with the set interval.

In an embodiment, obtaining the lane line information of the road section connected by the intersection may include obtaining the lane line information of the road section connected by the intersection from a traffic system. It should be noted that the traffic system refers to a system for storing traffic information, and the traffic information may include the lane line information.

At S104, the intersection missing traffic restriction information is determined based on the lane line information.

It should be noted that the traffic restriction information refers to regulations of a dispersion, ban, restriction or direction set for a movement of vehicles and pedestrians on the road and other traffic-related activities by relevant agencies. The type of the traffic restriction information is not limited here.

In an embodiment, the traffic restriction information may include restriction information for a travel direction, such as restriction information of no straight ahead, no left turn, no U turn and no right turn, which individually refers to restriction information for a straight direction, a left-turn direction, a U-turn direction and a right-turn direction.

In an embodiment, the traffic restriction information may include simple traffic restriction information and cross-intersection traffic restriction information. It should be noted that the simple traffic restriction information refers to restriction information from one travel direction to another travel direction at the same intersection, and the cross-intersection traffic restriction information refers to restriction information between the entry road section and the exit road section cross at least two intersections. For example, the cross-intersection traffic restriction information may include restriction information between the crossroad and the complex intersection.

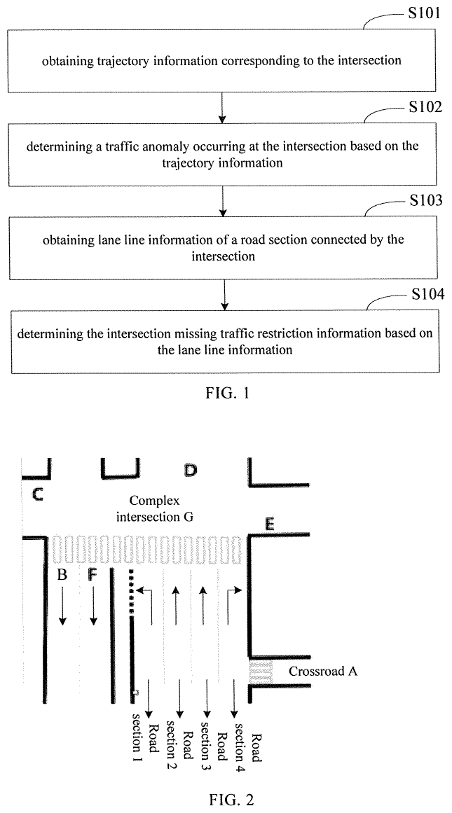

As shown in FIG. 2, it can only access to road section 4 from crossroad A while cannot access to road sections 1, 2 and 3, where road sections 1, 2, 3 and 4 are oriented for left turn and U turn, straight ahead, straight ahead and right turn, respectively; and at the complex intersection G, it can only exit from road section E and cannot exit from sections B, C, D and F, indicating that there is the cross-intersection traffic restriction information on no straight ahead, no left turn and no U turn between the crossroad A and the complex intersection G.

In an embodiment, the traffic restriction information may include virtual traffic restriction information and actual traffic restriction information. It should be noted that the virtual traffic restriction information refers to traffic restriction information that can be deducted from the traffic information (e.g., the lane line information) without a sign, while the actual traffic restriction information refers to traffic restriction information with the sign. The sign may include a signpost, a ground sign and the like.

In an embodiment, determining the intersection missing traffic restriction information based on the lane line information may include: determining the intersection meeting a set condition of a lack of the traffic restriction information based on the lane line information, thereby determining the intersection missing the traffic restriction information. It should be noted that the set condition of a lack of the traffic restriction information may be set as desired, which is not further limited here. For example, the set condition of the missing traffic restriction information may be one or more. For example, different categories of the traffic restriction information may correspond to different set conditions.

In an embodiment, determining the intersection missing traffic restriction information based on the trajectory information may include: inputting the trajectory information into a set model, which is used to recognize a status of the traffic restriction information in the intersection based on the trajectory information and output the status of the traffic restriction information in the intersection. The status of the traffic restriction information includes a missing status and not missing status. It should be noted that the set model may be set as desired, which is not limited here. For example, there may be one or more set model. For example, different categories of the traffic restriction information may correspond to different set models.

In conclusion, according to the method for determining an intersection missing traffic restriction information of the embodiment of the disclosure, it is determined that a traffic anomaly occurs at the intersection based on the trajectory information corresponding to the intersection, and the intersection missing traffic restriction information can be further determined based on the lane line information of the road section connected by the intersection. Therefore, the intersection missing traffic restriction information can be automatically determined based on the trajectory information and the lane line information, which has the advantages of high efficiency, high accuracy and low labor costs.

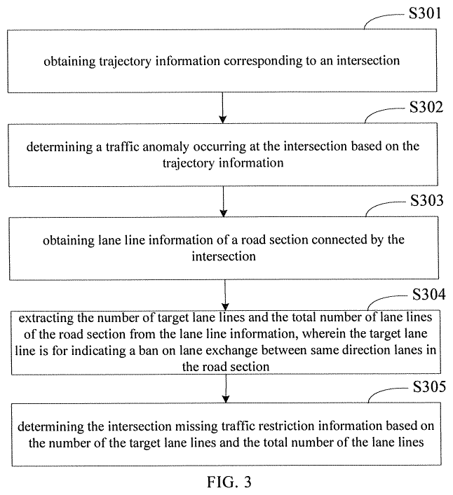

FIG. 3 is a flowchart of a method for determining an intersection missing traffic restriction information according to a third embodiment of the disclosure.

As shown in FIG. 3, the method for determining an intersection missing traffic restriction information according to the third embodiment of the disclosure includes S301-S305.

At S301, trajectory information corresponding to an intersection is obtained.

At S302, it is determined that a traffic anomaly occurs at the intersection based on the trajectory information.

At S303, lane line information of a road section connected by the intersection is obtained. The relevant contents of steps S301-S303 may be referred to the above embodiments and will not be repeated here.

At S304, the number of target lane lines and the total number of lane lines of the road section are extracted from the lane line information, in which the target lane line is for indicating a ban on lane exchange between same direction lanes in the road section.

It should be noted that there is no further limitation for the lane line and the target lane line. For example, the lane line may include a single white solid line, a double white solid line, a single yellow solid line, a double yellow solid line, a single white dotted line and a double white dotted line; and the target lane line may include a single white solid line.

In an embodiment, the lane line information may include color, number, shape and dotted or solid line of the lane line. The number of the target lane lines and/or the total number of the lane lines in the road section may be extracted from the lane line information. For example, if the target lane line is a single white solid line and there are three lane lines in the road section that are white, single, straight and solid according to the lane line information, the number of the target lane lines extracted from the lane line information is 3. If the total number of the lane lines in the road section is 5, the total number of the lane lines extracted from the lane line information is 5.

At S305, the intersection missing traffic restriction information is determined based on the number of the target lane lines and the total number of the lane lines.

In an embodiment, determining the intersection missing traffic restriction information based on the number of the target lane lines and the total number of the lane lines may include: obtaining a ratio of the number of the target lane lines to the total number of the lane lines; and determining the intersection missing traffic restriction information, in response to the ratio being greater than a first preset threshold value, in which the ratio greater than the first preset threshold indicates that the target lane line takes a large proportion in the lane lines. It should be noted that the first preset threshold value is not limited specifically here, for example, the first preset threshold value may be 50%, 60% and the like. Accordingly, the method can determine the intersection missing traffic restriction information based on the ratio of the number of the target lane lines to the total number of the lane lines being greater than the first preset threshold value, which determines the intersection missing traffic restriction information by comprehensively considering the number of the target lane lines and the total number of the lane lines.

In an embodiment, determining the intersection missing traffic restriction information based on the number of the target lane lines and the total number of the lane lines may include: obtaining a difference value between the total number of the lane lines and the number of the target lane lines, and determining the intersection missing traffic restriction information in response to the difference value being less than a preset threshold value, in which the difference value less than the preset threshold value indicates that there is a small difference between the number of the target lane lines and the total number of the lane lines, i.e., the number of the target lane lines is closer to the total number of the lane lines. It should be noted that the preset threshold is not limited specifically here, for example, the preset threshold may be 1, 2 and the like. Therefore, the method can determine the intersection missing traffic restriction information based on the difference value between the total number of the lane lines and the number of the target lane lines being less than the preset threshold, which determines the intersection missing traffic restriction information by comprehensively considering the number of the target lane lines and the total number of the lane lines.

In another embodiment, the intersection missing traffic restriction information may be determined based on the number of the target lane lines. For example, the number of the target lane lines being greater than a preset threshold value indicates that the number of the target lane lines is too large, and it is determined that the intersection lacks the traffic restriction information. It should be noted that the preset threshold value is not limited here, for example, the preset threshold value may be 2, 3 and the like. Accordingly, the method can directly determine the intersection missing traffic restriction information based on the number of the target lane lines being greater than the preset threshold value.

In conclusion, according to the method for determining an intersection missing traffic restriction information of the embodiments of the disclosure, the number of the target lane lines and the total number of the lane lines are extracted from the lane line information, in which the target lane line is for indicating a ban on lane exchange between same direction lanes in the road section. Therefore, the intersection missing traffic restriction information can be automatically determined based on the number of the target lane lines and the total number of the lane lines.

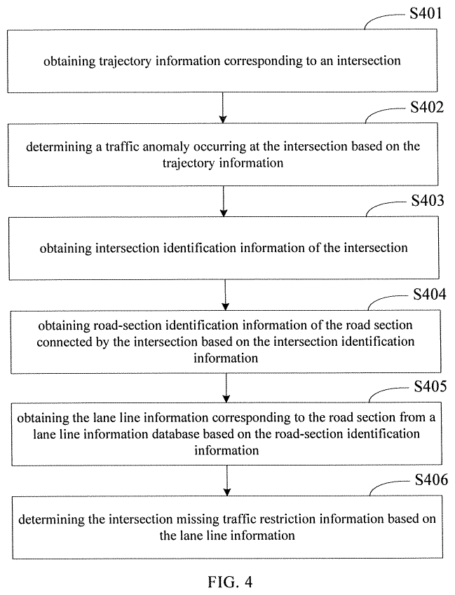

FIG. 4 is a flowchart of a method for determining an intersection missing traffic restriction information according to a fourth embodiment of the disclosure.

As shown in FIG. 4, the method for determining an intersection missing traffic restriction information according to the fourth embodiment of the disclosure includes S401-S406.

At S401, trajectory information corresponding to an intersection is obtained.

At S402, it is determined that a traffic anomaly occurs at the intersection based on the trajectory information.

The relevant contents of steps S401-S402 may be referred to the above embodiments and will not be repeated here.

At S403, intersection identification information of the intersection is obtained.

At S404, road-section identification information of the road section connected by the intersection is obtained based on the intersection identification information.

In the embodiments of the disclosure, after a traffic anomaly occurring at the intersection is determined, the intersection identification information of the intersection may be obtained, and the road-section identification information of the road section connected by the intersection may be obtained based on the intersection identification information. It should be noted that the categories of identification information are not limited specifically, for example, the identification information may include, but is not limited to, a location, placename and the like.

In an embodiment, a mapping relation or a mapping table between the intersection identification information and the road-section identification information may be preset, and after the intersection identification information is obtained, by querying the above mapping relation or mapping table, the road-section identification information mapped by the intersection identification information may be obtained, which may be determined as the road-section identification information of the road section connected by the intersection. It should be noted that there is no further limitation for the above mapping relation or mapping table.

At S405, the lane line information corresponding to the road section is obtained from a lane line information database based on the road-section identification information.

It is to be noted that the lane line information database refers to a storage space storing the lane line information, and the lane line information database may be set as desired, which is not limited here.

In an embodiment, obtaining the lane line information corresponding to the road section from the lane line information database based on the road-section identification information may include: taking the road-section identification information as a query key value; querying the query key value in the lane line information database; and determining the queried lane line information as the lane line information corresponding to the road section.

In an embodiment, a picture of the intersection may be collected, from which the lane line information of the road section connected by the intersection may be extracted, and the lane line information database may be updated based on the extracted lane line information. For example, the extracted lane line information may be compared with the lane line information stored in the lane line information database, and in the event that the extracted lane line information is inconsistent with the stored lane line information, the stored lane line information may be replaced by the extracted lane line information. In the event that the extracted lane line information does not exist in the lane line information database, the extracted lane line information may be added into the lane line information database.

At S406, the intersection missing traffic restriction information is determined based on the lane line information.

The relevant contents of step S406 may be referred to the above embodiments and will not be repeated here.

In conclusion, according to the method for determining an intersection missing traffic restriction information of the embodiments of the disclosure, the road-section identification information of the road section connected by the intersection is obtained based on the intersection identification information of the intersection, and the lane line information corresponding to the road section is obtained from the lane line information database based on the road-section identification information, thus realizing an automatic acquisition of the lane line information.

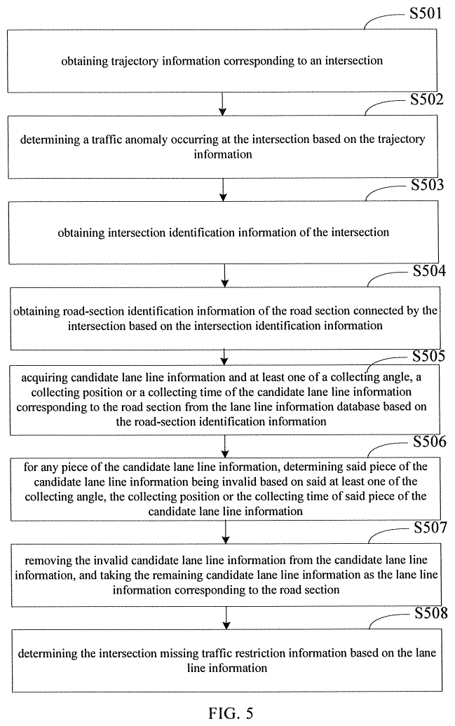

FIG. 5 is a flowchart of a method for determining an intersection missing traffic restriction information according to a fifth embodiment of the disclosure.

As shown in FIG. 5, the method for determining an intersection missing traffic restriction information according to the fifth embodiment of the disclosure includes S501-S508.

At S501, trajectory information corresponding to an intersection is obtained.

At S502, it is determined that a traffic anomaly occurs at the intersection based on the trajectory information.

At S503, intersection identification information of the intersection is obtained.

At S504, road-section identification information of the road section connected by the intersection is obtained based on the intersection identification information.

The relevant contents of steps S501-S504 may be referred to the above embodiments and will not be repeated here.

At S505, candidate lane line information and at least one of a collecting angle, a collecting position or a collecting time of the candidate lane line information corresponding to the road section are acquired from the lane line information database based on the road-section identification information.

It is to be noted that the relevant contents of acquiring the candidate lane information corresponding to the road section from the lane line information database based on the road-section identification information may be referred to the above embodiments and will not be repeated here.

It is noted that the lane line information database is also used to store at least one of the collecting angle, collecting position or collecting time.

In an embodiment, the candidate lane line information includes at least one of the collecting angle, collecting position or collecting time, and said at least one of the collecting angle, collecting position or collecting time may be extracted from the candidate lane line information.

At S506, for any piece of the candidate lane line information, it is determined that the piece of the candidate lane line information is invalid based on said at least one of the collecting angle, the collecting position or the collecting time of the piece of the candidate lane line information.

In an embodiment, determining a piece of the candidate lane line information being invalid based on said at least one of the collecting angle, the collecting position or the collecting time of the piece of the candidate lane line information may include: determining the piece of the candidate lane line information being invalid based on said at least one of the collecting angle, the collecting position or the collecting time of the piece of the candidate lane line information, in response to the piece of the candidate lane line information meeting a preset invalid condition. It should be noted that the preset invalid condition may be set as desired, which is not limited here. For example, the preset invalid condition may be one or more.

In an embodiment, determining a piece of the candidate lane line information being invalid based on said at least one of the collecting angle, the collecting position or the collecting time of the piece of the candidate lane line information may include: determining the piece of the candidate lane line information being invalid in response to a difference value between the collecting angle and a preset angle being greater than or equal to a preset fifth threshold value, and/or a difference value between the collecting position and a preset position being greater than or equal to a preset sixth threshold value, and/or a difference value between the collecting time and the current time being greater than or equal to a preset seventh threshold value, which indicate that the difference value between the collecting angle and the preset angle, and/or the difference value between the collecting position and the preset position, and/or the difference value between the collecting time and the current time are too large respectively.

It should be noted that the preset angle, preset position, the preset fifth threshold value, the preset sixth threshold value and the preset seventh threshold value are not limited here. For example, the preset angle may be an angle of entering the road section from the intersection, and the preset position may be a middle position of the road section.

At S507, the invalid candidate lane line information is removed from the candidate lane line information, and the remaining candidate lane line information is taken as the lane line information corresponding to the road section.

In the embodiments of the disclosure, the invalid candidate lane information may be removed from the candidate lane line information. That is, after the deletion, the remaining candidate lane line information only includes valid candidate lane line information, and the remaining candidate lane line information is determined as the lane line information corresponding to the road section.

At S508, the intersection missing traffic restriction information is determined based on the lane line information.

The relevant contents of step S508 may be referred to the above embodiments and will not be repeated here.

In conclusion, according to the method for determining an intersection missing traffic restriction information of the embodiments of the disclosure, it is determined that the candidate lane line information is invalid based on at least one of the collecting angle, the collecting position or the collecting time of the candidate lane line information, and the invalid candidate lane line information is removed from the candidate lane line information, and the remaining candidate lane line information is determined as the lane line information corresponding to the road section, which ensures the accuracy of the obtained lane line information.

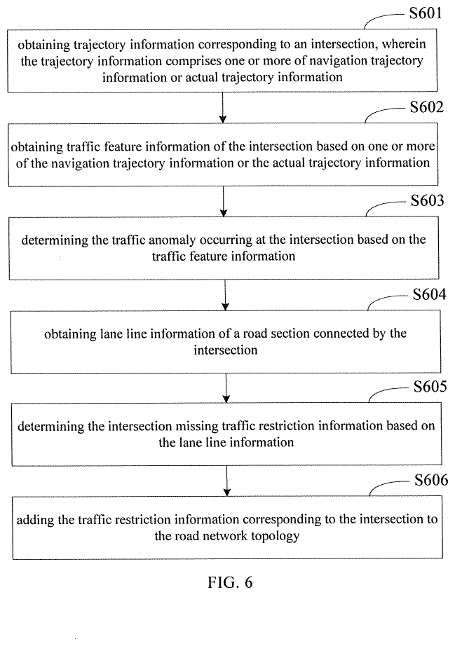

FIG. 6 is a flowchart of a method for determining an intersection missing traffic restriction information according to a sixth embodiment of the disclosure.

As shown in FIG. 6, the method for determining an intersection missing traffic restriction information according to the sixth embodiment of the disclosure includes S601-S606.

At S601, trajectory information corresponding to an intersection is obtained, in which the trajectory information includes navigation trajectory information and/or actual trajectory information.

In the embodiments of the disclosure, the trajectory information corresponding to the intersection may include the navigation trajectory information and/or actual trajectory information. It should be noted that the navigation trajectory information refers to virtual trajectory information generated by a navigation tool, such as a navigation application (APP), a navigation web page and the like. The actual trajectory information refers to real trajectory information of vehicles and pedestrians. For example, the navigation trajectory information may include the navigation trajectory information from entry through an entry road section of the intersection to exit through an exit road section of the intersection, and the actual trajectory information may include an entry trajectory and exit trajectory through the road section connected by the intersection.

In an embodiment, in a situation that the traffic restriction is a cross-intersection traffic restriction, obtaining the navigation trajectory information may include: obtaining a road network topology; acquiring a plurality of complex intersections based on the road network topology; acquiring a crossroad connected with the plurality of complex intersections based on the road network topology; and obtaining navigation trajectory information between the crossroad and the complex intersection as the navigation trajectory information corresponding to the intersection, based on the road network topology. Therefore, based on the traffic restriction being the cross-intersection traffic restriction, the method acquires the complex intersection based on the road network topology, and further acquires the crossroad connected with the complex intersection, and obtains the navigation trajectory information between the crossroad and the complex intersection as the navigation trajectory information corresponding to the intersection.

It should be noted that the road network topology may be set as desired, which is not limited here. In an embodiment, the road network topology includes a plurality of nodes and edges, in which the node represents a start point or an end point of a road section, and the edge represents a road section.

In an embodiment, with an acquisition for a plurality of the complex intersections based on the road network topology, the complex intersection may be extended to its surrounding road section based on the road network topology, and a target road section may be selected from the surrounding road section according to the road-section feature information. Further, an entry road section and an exit road section are obtained from the target road section, and the crossroad connected with the complex intersection is obtained based on an angle between the entry road section and the exit road section.

It is noted that the category of the road-section feature information is not limited here. For example, the road-section feature information includes but is not limited to a location, road-section grade, form, the number of lane lines and a turning angle. It is noted that the road-section grade is a high-speed road, national road, provincial road, county road, township road, ferry, walking road and the like in a descending order. The form includes but is not limited to a trunk road section, overpass, auxiliary road, roundabout, ramp, bus lane and the like. The turning angle refers to a turning angle from the entry road section toward the exit road section.

In an embodiment, selecting the target road section from the surrounding road section based on the road-section feature information may include: deleting the high-speed road section, roundabout, walking road, entrances and exits of a main and an auxiliary road, a road section within the intersection, the ferry and the like from the surrounding road section, and determining the remaining surrounding road section after the deletion as the target road section.

In an embodiment, obtaining the actual trajectory information may include obtaining a set of the trajectory points and the road network topology to be matched, matching the set of the trajectory point with the road network topology to obtain a target point of each trajectory point in the road network topology, and generating the actual trajectory information based on each target point.

For example, the set of the trajectory point may be input into a pre-trained Hidden Markov Model (HMM), and a status prediction on the set of the trajectory point may be performed with the HMM to output an initial status probability of each candidate status, an observation probability of each trajectory point under each candidate status, and a status transition probability between the candidate status of any two adjacent trajectory points, in which the candidate status is for representing a candidate point of the trajectory point in the road network topology.

Further, according to the initial status probability, the observation probability and the status transition probability, a target status is determined from the candidate status, where the target status is for representing the target point of the trajectory point in the road network topology. For example, the initial status probability, the observation probability and the status transition probability may be input into a Viterbi algorithm to output the target status of the trajectory point with the Viterbi algorithm.

At S602, traffic feature information of the intersection is obtained based on the navigation trajectory information and/or the actual trajectory information.

It is noted that the category of the traffic feature information is not limited.

For example, the traffic feature information includes but is not limited to at least one of a traffic volume, a detour volume, a yaw volume, a traffic detour ratio or a traffic exit ratio in the road section connected by the intersection. It should be noted that the traffic volume refers to the amount of the trajectory entering the intersection through the entry road section, exiting the intersection through the exit road section without any detour. The detour volume refers to the amount of the trajectory entering the intersection through the entry road section, exiting the intersection through the exit road section with detour. The yaw volume refers to the amount of the trajectory entering the intersection through the entry road section but not exiting the intersection through the exit road section. The traffic detour ratio is a ratio of the traffic volume to the detour volume. The traffic exit ratio includes a ratio of the amount of the trajectory in any exit direction in the road section to the total amount of the trajectory in the exit direction, where the exit direction includes, but is not limited to, left turn, straight ahead, right turn, U turn and the like.

In an embodiment, the traffic feature information further includes a traffic timing sequence feature, a detour timing sequence feature and the like. It should be noted that the traffic timing sequence feature refers to a feature representing a change of the traffic volume over time, which may be shown by a graph with the traffic volume on the vertical axis and time on the horizontal axis. The detour timing sequence feature refers to a feature representing a change of the detour volume over time, which may be shown by a graph with the detour volume on the vertical axis and time on the horizontal axis.

In an embodiment, obtaining the traffic feature information of the intersection based on the navigation trajectory information and/or the actual trajectory information may include comparing the navigation trajectory information with the actual trajectory information, and obtaining the traffic volume, the detour volume, the yaw volume, the traffic detour ratio, etc. based on a comparison result. For example, the entry road section and the exit road section may be obtained based on the navigation trajectory information, and based on the comparison result indicating any actual trajectory information entering the intersection through the entry road section, exiting the intersection through the exit road section without any detour, the traffic volume may plus one; based on the comparison result indicating any actual trajectory information entering the intersection through the entry road section, exiting the intersection through the exit road section with detour, the detour volume may plus one; and based on the comparison result indicating any actual trajectory information entering the intersection through the entry road section but not exiting the intersection through the exit road section, the yaw volume may plus one.

In an embodiment, obtaining the traffic feature information of the intersection based on the navigation trajectory information and/or the actual trajectory information may include obtaining the traffic exit ratio of the road section based on the actual trajectory information. For example, if the amount of the trajectory at the exit direction of left turn in the road section is 10 and the total amount of the trajectory at the exit direction is 50, the traffic exit ratio at the exit direction of left turn in the road section is of 1:5.

At S603, it is determined that the traffic anomaly occurs at the intersection based on the traffic feature information.

In an embodiment, determining the traffic anomaly occurring at the intersection based on the traffic feature information may include: determining the intersection meeting a set condition of an occurrence of the traffic anomaly based on the traffic feature information, thereby determining that a traffic anomaly occurs at the intersection. It should be noted that the set condition of an occurrence of a traffic anomaly may be set as desired, which is not limited here. For example, there may be one or more set condition of the traffic anomaly.

In an embodiment, determining the traffic anomaly occurring at the intersection based on the traffic feature information may include: determining the traffic anomaly occurring at the intersection in response to the traffic volume corresponding to the intersection being less than a second threshold value, and/or the detour volume being greater than a third threshold value, and/or the traffic detour ratio being less than a fourth threshold value, which indicate that the traffic volume is too small, and/or the detour volume is too large, and/or a ratio of the traffic volume to the detour volume is too small, respectively. It should be noted that there is no further limitation on the second threshold, the third threshold and the fourth threshold.

In an embodiment, determining the traffic anomaly occurring at the intersection based on the traffic feature information may include: determining the traffic anomaly occurring at the intersection in response to the yaw volume corresponding to the intersection being larger than a set threshold value, which indicates that the yaw volume corresponding to the intersection is too large. It should be noted that the set threshold value is not limited here.

In an embodiment, determining the traffic anomaly occurring at the intersection based on the traffic feature information may include: determining the traffic anomaly occurring at the intersection in response to the traffic exit ratio in at least one exit direction in the road section connected by the intersection being less than a preset eighth threshold value, and/or the traffic exit ratio in at least one exit direction being greater than a preset ninth threshold value, and/or a ratio of the traffic exit ratios in any two exit directions being greater than a preset tenth threshold, which indicates that the traffic exit ratio in at least one exit direction in the road section connected by the intersection is too small, and/or the traffic exit ratio in at least one exit direction in the road section is too large, and/or a difference between the traffic exit ratios in any two exit directions is too large, respectively. It should be noted that there is no further limitation on the preset eighth threshold value, the preset ninth threshold value and the preset tenth threshold value.

At S604, lane line information of a road section connected by the intersection is obtained.

At S605, the intersection missing traffic restriction information is determined based on the lane line information.

The relevant contents of steps S604-S605 may be referred to the above embodiments and will not be repeated here.

At S606, the traffic restriction information corresponding to the intersection is added to the road network topology.

In the embodiment, the road network topology may be further used for storing the traffic restriction information. After determining the intersection missing traffic restriction information, the traffic restriction information of the intersection may be added to the road network topology, to update the road network topology timely, thereby ensuring the realtime and accuracy of the road network topology.

In an embodiment, the road network topology may be set in a navigation APP for generating the navigation trajectory information.

In conclusion, according to the method for determining an intersection missing traffic restriction information according to the embodiments of the disclosure, the traffic feature information of the intersection is obtained based on the navigation trajectory information and/or actual trajectory information, and the intersection missing traffic restriction information can be automatically determined based on the traffic feature information.

The collection, storage, use, processing, transmission, provision and disclosure of personal information of users involved in the technical solution of the disclosure are handled in accordance with relevant laws and regulations and are not contrary to public order and morality.

According to the embodiment of the disclosure, the disclosure further provides an apparatus for determining an intersection missing traffic restriction information, which is used to implement the above method for determining an intersection missing traffic restriction information.

FIG. 7 is a block diagram of an apparatus for determining an intersection missing traffic restriction information according to the first embodiment of the disclosure.

As shown in FIG. 7, an apparatus 700 for determining an intersection missing traffic restriction information of the embodiment of the disclosure includes: a first obtaining module 701, a first determining module 702, a second obtaining module 703 and a second determining module 704.

The first obtaining module 701 is configured to obtain trajectory information corresponding to an intersection.

The first determining module 702 is configured to determine a traffic anomaly occurring at the intersection based on the trajectory information.

The second obtaining module 703 is configured to obtain lane line information of a road section connected by the intersection.

The second determining module 704 is configured to determine the intersection missing traffic restriction information based on the lane line information.

In an embodiment of the disclosure, the second obtaining module 703 is further configured to: extract the number of target lane lines and the total number of lane lines of the road section from the lane line information, wherein the target lane line is for indicating a ban on lane exchange between same direction lanes in the road section; and determine the intersection missing traffic restriction information based on the number of the target lane lines and the total number of the lane lines.

In an embodiment of the disclosure, the second obtaining module 703 is further configured to: a ratio of the number of the target lane lines to the total number of the lane lines; and determine the intersection missing traffic restriction information, in response to the ratio being greater than a first preset threshold value.

In an embodiment of the disclosure, the second obtaining module 703 is further configured to: obtain intersection identification information of the intersection; obtain road-section identification information of the road section connected by the intersection based on the intersection identification information; and obtain the lane line information corresponding to the road section from a lane line information database based on the road-section identification information.

In an embodiment of the disclosure, the second obtaining module 703 is further configured to: acquire candidate lane line information and at least one of a collecting angle, a collecting position or a collecting time of the candidate lane line information corresponding to the road section from the lane line information database based on the road-section identification information; for any piece of the candidate lane line information, determine said piece of the candidate lane line information being invalid based on said at least one of the collecting angle, the collecting position or the collecting time of said piece of the candidate lane line information; and remove the invalid candidate lane line information from the candidate lane line information, and take the remaining candidate lane line information as the lane line information corresponding to the road section.

In an embodiment of the disclosure, the trajectory information includes navigation trajectory information and/or actual trajectory information, and the first determining module 702 is further configured to: obtain traffic feature information of the intersection based on the navigation trajectory information and/or the actual trajectory information; and determine the traffic anomaly occurring at the intersection based on the traffic feature information.

In an embodiment of the disclosure, the traffic feature information comprises at least one of a traffic volume, a detour volume, a yaw volume, a traffic detour ratio or a traffic exit ratio in the road section connected by the intersection, where the traffic detour ratio is a ratio of the traffic volume to the detour volume, and the traffic exit ratio includes a ratio of a trajectory volume in any exit direction of the road section to a total trajectory volume in the exit direction.

In an embodiment of the disclosure, the first determining module 702 is further configured to: determine the traffic anomaly occurring at the intersection in response to the traffic volume corresponding to the intersection being less than a preset second threshold value, and/or the detour volume being greater than a preset third threshold value, and/or the traffic detour ratio being less than a preset fourth threshold value.

In an embodiment of the disclosure, based on the traffic restriction being a cross-intersection traffic restriction, the first obtaining module 701 is further configured to: obtain a road network topology; acquire a plurality of complex intersections based on the road network topology; acquire a crossroad connected with the plurality of complex intersections based on the road network topology; and obtain navigation trajectory information between the crossroad and the complex intersection as the navigation trajectory information corresponding to the intersection, based on the road network topology.

In an embodiment of the disclosure, the apparatus 700 further includes: an adding module, configured to add the traffic restriction information corresponding to the intersection to the road network topology.

In conclusion, with the apparatus for determining an intersection missing traffic restriction information of the embodiment of the disclosure, it is determined that a traffic anomaly occurs at the intersection based on the trajectory information corresponding to the intersection, and the intersection missing traffic restriction information can be further determined based on the lane line information of the road section connected by the intersection. Therefore, the intersection missing traffic restriction information can be automatically determined based on the trajectory information and the lane line information, which has the advantages of high efficiency, high accuracy and low labor costs.

According to the embodiments of the disclosure, the disclosure further provides an electronic device, a readable storage medium and a computer program product.

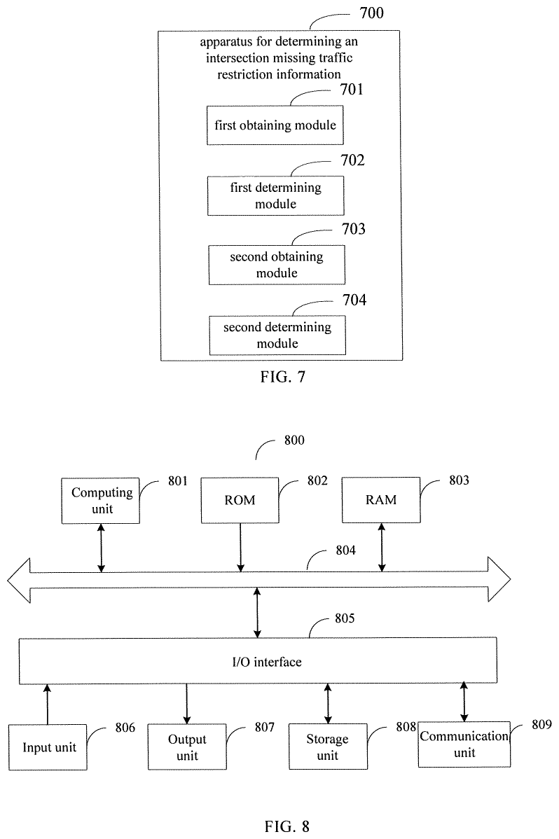

FIG. 8 is a block diagram of an electronic device 800 according to the embodiments of the disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examples, and are not intended to limit the implementation of the disclosure described and/or required herein.

As shown in FIG. 8, the electronic device 800 includes a computing unit 801 performing various appropriate actions and processes based on computer programs stored in a Read-Only Memory (ROM) 802 or computer programs loaded from the storage unit 808 to a Random Access Memory (RAM) 803. In the RAM 803, various programs and data required for the operation of the device 800 are stored. The computing unit 801, the ROM 802, and the RAM 803 are connected to each other through a bus 804. An Input/Output (I/O) interface 805 is also connected to the bus 804.

Components in the device 800 are connected to the I/O interface 805, including: an input unit 806, such as a keyboard, a mouse; an output unit 807, such as various types of displays, speakers; a storage unit 808, such as a disk, an optical disk; and a communication unit 809, such as network cards, modems, and wireless communication transceivers. The communication unit 809 allows the device 800 to exchange information/data with other devices through a computer network such as the Internet and/or various telecommunication networks.

The computing unit 801 may be various general-purpose and/or dedicated processing components with processing and computing capabilities. Some examples of computing unit 801 include, but are not limited to, a Central Processing Unit (CPU), a Graphics Processing Unit (GPU), various dedicated AI computing chips, various computing units that run machine learning model algorithms, and a Digital Signal Processor (DSP), and any appropriate processor, controller and microcontroller. The computing unit 801 executes the various methods and processes described above, such as the method for determining an intersection missing traffic restriction information as shown in FIG. 1 to FIG. 6. For example, in some embodiments, the method may be implemented as a computer software program, which is tangibly contained in a machine-readable medium, such as the storage unit 808. In some embodiments, part or all of the computer program may be loaded and/or installed on the device 800 via the ROM 802 and/or the communication unit 809. When the computer program is loaded on the RAM 803 and executed by the computing unit 801, one or more steps of the method described above may be executed. Alternatively, in other embodiments, the computing unit 801 may be configured to perform the method in any other suitable manner (for example, by means of firmware).

Various implementations of the systems and techniques described above may be implemented by a digital electronic circuit system, an integrated circuit system, Field Programmable Gate Arrays (FPGAs), Application Specific Integrated Circuits (ASICs), Application Specific Standard Products (ASSPs), System On Chip (SOCs), Complex Programmable Logic Devices (CPLDs), computer hardware, firmware, software, and/or a combination thereof. These various embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program code configured to implement the method of the disclosure may be written in any combination of one or more programming languages. These program codes may be provided to the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage media include electrical connections based on one or more wires, portable computer disks, hard disks, RAM, ROM, Electrically Programmable Read-Only-Memory (EPROM), flash memory, fiber optics, Compact Disc Read-Only Memory (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: Local Area Network (LAN), Wide Area Network (WAN), and the Internet.

The computer system may include a client and a server. The client and server are generally remote from each other and interacting through a communication network. The client-server relation is generated by computer programs running on the respective computers and having a client-server relation with each other. The server may be a cloud server, also known as a cloud computing server or a cloud host, which is a host product in the cloud computing service system, to solve the defects of difficult management and weak business scalability in the traditional physical host and Virtual Private Server (VPS) service. The server may also be a server of distributed system or a server combined with block-chain.

According to the embodiment of the disclosure, the disclosure further provides a computer program product having computer programs stored thereon. When the computer programs are executed by a processor, the method for determining an intersection missing traffic restriction information as described in the above embodiments of the disclosure is implemented.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of the disclosure shall be included in the protection scope of the disclosure.

What is claimed is:

1. A method for determining an intersection missing traffic restriction information, comprising:
obtaining trajectory information corresponding to the intersection;
determining a traffic anomaly occurring at the intersection based on the trajectory information;
obtaining lane line information of a road section connected by the intersection; and
determining the intersection missing traffic restriction information based on the lane line information.

2. The method of claim 1, wherein determining the intersection missing traffic restriction information based on the lane line information comprises:
extracting the number of target lane lines and the total number of lane lines of the road section from the lane line information, wherein the target lane line is for indicating a ban on lane exchange between same direction lanes in the road section; and
determining the intersection missing traffic restriction information based on the number of the target lane lines and the total number of the lane lines.

3. The method of claim 2, wherein determining the intersection missing traffic restriction information based on the number of the target lane lines and the total number of the lane lines comprises:
obtaining a ratio of the number of the target lane lines to the total number of the lane lines; and
determining the intersection missing traffic restriction information, in response to the ratio being greater than a first preset threshold value.

4. The method of claim 1, wherein obtaining lane line information of a road section connected by the intersection comprises:
obtaining intersection identification information of the intersection;
obtaining road-section identification information of the road section connected by the intersection based on the intersection identification information; and
obtaining the lane line information corresponding to the road section from a lane line information database based on the road-section identification information.

5. The method of claim 4, wherein obtaining the lane line information corresponding to the road section from a lane line information database based on the road-section identification information comprises:
acquiring candidate lane line information and at least one of a collecting angle, a collecting position or a collecting time of the candidate lane line information corresponding to the road section from the lane line information database based on the road-section identification information;
for any piece of the candidate lane line information, determining said piece of the candidate lane line information being invalid based on said at least one of the collecting angle, the collecting position or the collecting time of said piece of the candidate lane line information; and
removing the invalid candidate lane line information from the candidate lane line information, and taking the remaining candidate lane line information as the lane line information corresponding to the road section.

6. The method of claim 1, wherein the trajectory information comprises one or more of navigation trajectory information or actual trajectory information, and determining a traffic anomaly occurring at the intersection based on the trajectory information comprises:
obtaining traffic feature information of the intersection based on one or more of the navigation trajectory information or the actual trajectory information; and
determining the traffic anomaly occurring at the intersection based on the traffic feature information.

7. The method of claim 6, wherein the traffic feature information comprises at least one of a traffic volume, a detour volume, a yaw volume, a traffic detour ratio or a traffic exit ratio in the road section connected by the intersection, wherein the traffic detour ratio is a ratio of the traffic volume to the detour volume, and the traffic exit ratio comprises a ratio of a trajectory volume in any exit direction of the road section to a total trajectory volume in the exit direction.

8. The method of claim 7, wherein determining the traffic anomaly occurring at the intersection based on the traffic feature information comprises:
determining the traffic anomaly occurring at the intersection in response to one or more of the traffic volume corresponding to the intersection being less than a preset second threshold value, the detour volume being greater than a preset third threshold value or the traffic detour ratio being less than a preset fourth threshold value.

9. The method of claim 6, wherein based on the traffic restriction being a cross-intersection traffic restriction, obtaining the navigation trajectory information comprises:
obtaining a road network topology;
acquiring a plurality of complex intersections based on the road network topology;
acquiring a crossroad connected with the plurality of complex intersections based on the road network topology; and
obtaining navigation trajectory information between the crossroad and the complex intersection as the navigation trajectory information corresponding to the intersection, based on the road network topology.

10. The method of claim 1, wherein after determining the intersection missing traffic restriction information, the method further comprises:
adding the traffic restriction information corresponding to the intersection to the road network topology.

11. An electronic device, comprising:
at least one processor; and
a memory, connected in communication with said at least one processor,
wherein the memory stores therein instructions executable by said at least one processor, the instructions, that are executed by said at least one processor, implements a method for determining an intersection missing traffic restriction information comprising:
obtaining trajectory information corresponding to the intersection;
determining a traffic anomaly occurring at the intersection based on the trajectory information;
obtaining lane line information of a road section connected by the intersection; and
determining the intersection missing traffic restriction information based on the lane line information.

12. The electronic device of claim 11, wherein determining the intersection missing traffic restriction information based on the lane line information comprises:
extracting the number of target lane lines and the total number of lane lines of the road section from the lane line information, wherein the target lane line is for indicating a ban on lane exchange between same direction lanes in the road section; and
determining the intersection missing traffic restriction information based on the number of the target lane lines and the total number of the lane lines.

13. The electronic device of claim 12, wherein determining the intersection missing traffic restriction information based on the number of the target lane lines and the total number of the lane lines comprises:
obtaining a ratio of the number of the target lane lines to the total number of the lane lines; and
determining the intersection missing traffic restriction information, in response to the ratio being greater than a first preset threshold value.

14. The electronic device of claim 11, wherein obtaining lane line information of a road section connected by the intersection comprises:
obtaining intersection identification information of the intersection;
obtaining road-section identification information of the road section connected by the intersection based on the intersection identification information; and
obtaining the lane line information corresponding to the road section from a lane line information database based on the road-section identification information.

15. The electronic device of claim 14, wherein obtaining the lane line information corresponding to the road section from a lane line information database based on the road-section identification information comprises:
acquiring candidate lane line information and at least one of a collecting angle, a collecting position or a collecting time of the candidate lane line information corresponding to the road section from the lane line information database based on the road-section identification information;
for any piece of the candidate lane line information, determining said piece of the candidate lane line information being invalid based on said at least one of the collecting angle, the collecting position or the collecting time of said piece of the candidate lane line information; and
removing the invalid candidate lane line information from the candidate lane line information, and taking the remaining candidate lane line information as the lane line information corresponding to the road section.

16. The electronic device of claim 11, wherein the trajectory information comprises one or more of navigation trajectory information or actual trajectory information, and determining a traffic anomaly occurring at the intersection based on the trajectory information comprises:
obtaining traffic feature information of the intersection based on one or more of the navigation trajectory information or the actual trajectory information; and
determining the traffic anomaly occurring at the intersection based on the traffic feature information.

17. The electronic device of claim 16, wherein the traffic feature information comprises at least one of a traffic volume, a detour volume, a yaw volume, a traffic detour ratio or a traffic exit ratio in the road section connected by the intersection, wherein the traffic detour ratio is a ratio of the traffic volume to the detour volume, and the traffic exit ratio comprises a ratio of a trajectory volume in any exit direction of the road section to a total trajectory volume in the exit direction.

18. The electronic device of claim 17, wherein determining the traffic anomaly occurring at the intersection based on the traffic feature information comprises:
determining the traffic anomaly occurring at the intersection in response to one or more of the traffic volume corresponding to the intersection being less than a preset second threshold value, the detour volume being greater than a preset third threshold value or the traffic detour ratio being less than a preset fourth threshold value.

19. The electronic device of claim 11, wherein after determining the intersection missing traffic restriction information, the method further comprises:
adding the traffic restriction information corresponding to the intersection to the road network topology.

20. A non-transitory computer-readable storage medium having computer instructions stored thereon, wherein the computer instructions are configured to cause a computer to implement a method for determining an intersection missing traffic restriction information, comprising:
obtaining trajectory information corresponding to the intersection;
determining a traffic anomaly occurring at the intersection based on the trajectory information;
obtaining lane line information of a road section connected by the intersection; and
determining the intersection missing traffic restriction information based on the lane line information.
